(19) United States
(12) Patent Application Publication
(10) Pub. No.: US 2004/0258886 A1
(43) Pub. Date: Dec. 23, 2004

(54) Absorbent tissue-towel products comprising related embossed and printed indicia

(75) Inventor: Kathleen Ann Murphy Maciag, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/874,865

(22) Filed: Jun. 23, 2004

Related U.S. Application Data
(60) Provisional application No. 60/480,634, filed on Jun. 23, 2003.

(51) Int. Cl. B32B 3/00

(52) U.S. Cl. 428/156; 428/195.1

(57) ABSTRACT

An absorbent tissue-towel product comprising paper substrate having a first surface and a second surface; a printed image disposed on at least one of first or second surfaces; and an embossed image disposed on at least one of first or second surfaces; wherein the embossed image and the printed image both represent elements of the same subject matter association.

### CROSS REFERENCE TO RELATED APPLICATIONS

This application claims the benefit of U.S. Provisional Application No. 60/480,634, filed Jun. 23, 2003.

### FIELD OF THE INVENTION

This invention relates to embossed and printed absorbent tissue-towel products where the embossed image is related to the printed image.

### BACKGROUND OF THE INVENTION

The desire to improve the aesthetic characteristics of sheet-type or web-type consumer products by both embossing and printing the product is very old. (U.S. Pat. No. 680,533, issued to Marinier et al. on Aug. 13, 1901.) Traditionally, the embossing patterns have been limited to geometric patterns of dots from the emboss knobs.

Applicant has discovered that many consumers find a tissue-towel product having an embossed image which is related to the print image much more aesthetically acceptable. The relationship must be supported by a theme from nature, business, literature or the like. Recent developments in technology to highly registered print and emboss graphics on absorbent, stretchable products, have allowed manufacturers to cost effectively meet this consumer expectation.

### SUMMARY OF THE INVENTION

The present invention relates to an absorbent tissue-towel product comprising:

a) paper substrate having a first surface and a second surface;

b) a printed indicia disposed on at least one of first or second surfaces; and

c) an embossed indicia disposed on at least one of first or second surfaces;

wherein the embossed indicia is related to the printed indicia.

### BRIEF DESCRIPTION OF THE DRAWINGS

While the specification concludes with claims which particularly point out and distinctly claim the present invention, it is believed that the present invention will be better understood from the following description of preferred embodiments, taken in conjunction with the accompanying drawings, in which like reference numerals identify identical elements and wherein:

FIG. 1 is a photographic image of a preferred embodiment of the present absorbent tissue-towel product having an emboss pattern and a printed image which represent the same literary association, i.e. SpongeBob SquarePants.

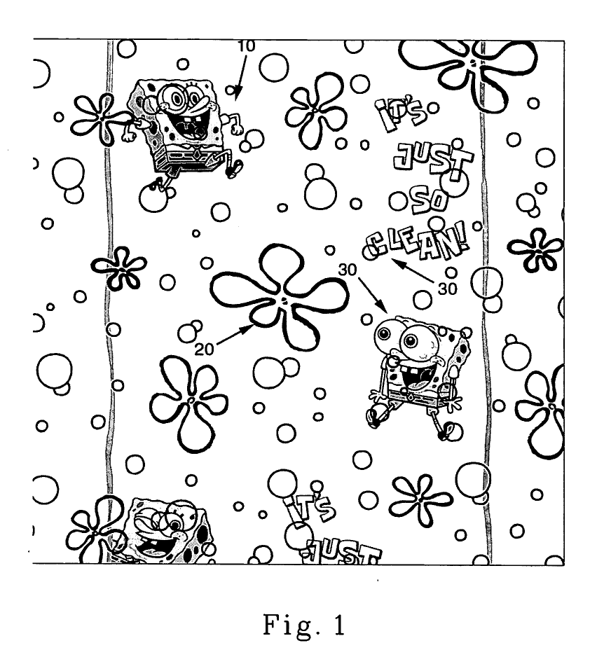

FIG. 2 is an photographic image of a preferred embodiment of the present absorbent tissue-towel product having an emboss pattern and a printed image which represent the same natural association, i.e. Cat with cat paws and “meow”.

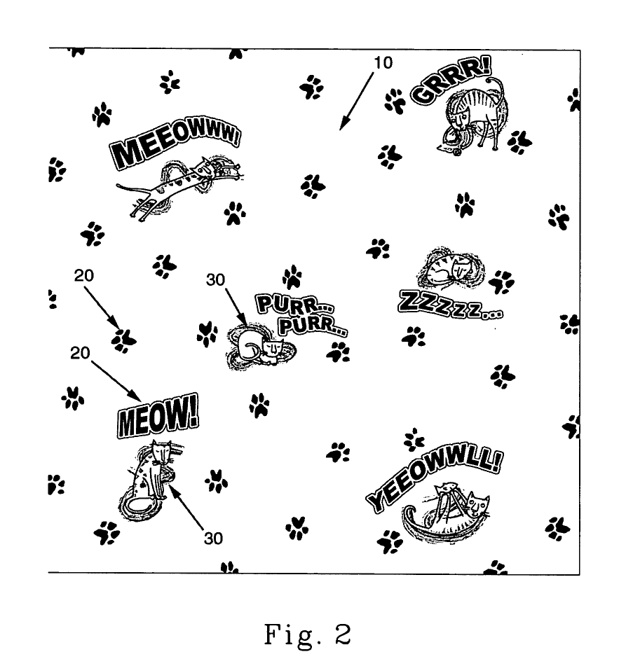

FIG. 3 is an photographic image of a preferred embodiment of the present absorbent tissue-towel product having an emboss pattern and a printed image where the embossed image and the print pattern represent images of objects in the same kingdom, i.e. flowers.

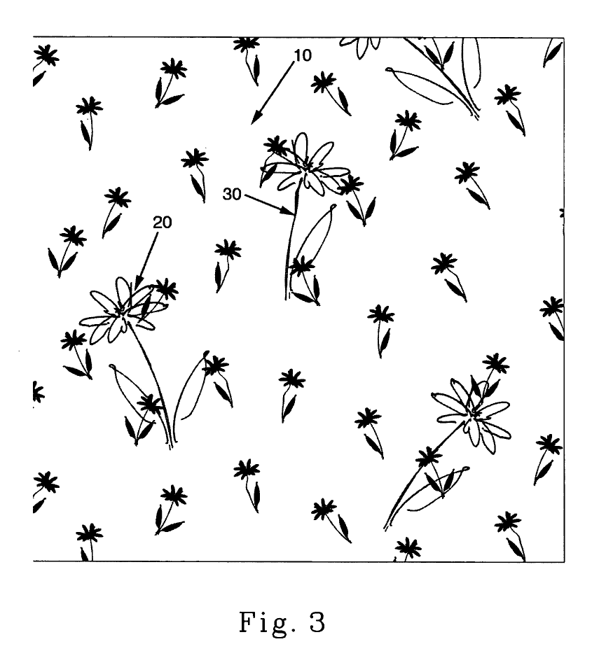

### DETAILED DESCRIPTION OF THE INVENTION

The present invention relates to absorbent tissue-towel products comprising paper substrate 10 having a first surface and a second surface, a printed image 30 disposed on at least one of first or second surfaces, and an embossed image 20 disposed on at least one of first or second surfaces, wherein the embossed image and the printed image both represent elements of the same subject matter association.

Tissue-Towel Products

The present invention is applicable to paper substrates 10 that comprise tissue paper or paper towel products in general, including but not limited to: conventionally felt-pressed tissue paper; pattern densified tissue paper; and high-bulk, uncompacted tissue paper. Non-limiting examples of tissue-towel products include toweling, facial tissue, bath tissue, and table napkins and the like. The tissue-towel products include single ply and multiply products and an individual ply may comprise one or more layers of papermaking materials depending on the preferred characteristics of the product. The tissue paper preferably has a basis weight of between about 10 g/m² and about 80 g/m², and density ranging from about 0.04 g/cm³ to about 0.80 g/cm³ or less. Preferably, the basis weight will be below about 35 lb/3000 ft² or less; and the density will be about 0.30 g/cc or less. Most preferably, the density will be between about 0.04 g/cc and about 0.20 g/cc.

Conventionally pressed tissue paper and methods for making such paper are known in the art. See commonly assigned U.S. patent application Ser. No. 09/997,950 filed Nov. 30, 2001. One preferred tissue paper is pattern densified tissue paper which is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Preferred processes for making pattern densified tissue webs are disclosed in U.S. Pat. No. 3,301,746, issued to Sanford and Sisson on Jan. 31, 1967, U.S. Pat. No. 3,974,025, issued to Ayers on Aug. 10, 1976, U.S. Pat. No. 4,191,609, issued to on Mar. 4, 1980, and U.S. Pat. No. 4,637,859, issued to on Jan. 20, 1987; U.S. Pat. No. 3,301,746, issued to Sanford and Sisson on Jan. 31, 1967, U.S. Pat. No. 3,821,068, issued to Salvucci, Jr. et al. on May 21, 1974, U.S. Pat. No. 3,974,025, issued to Ayers on Aug. 10, 1976, U.S. Pat. 3,573,164, issued to Friedberg, et al. on Mar. 30, 1971, U.S. Pat. No. 3,473,576, issued to Amneus on Oct. 21, 1969, U.S. Pat. No. 4,239,065, issued to Trokhan on Dec. 16, 1980, and U.S. Pat. No. 4,528,239, issued to Trokhan on Jul. 9, 1985,.

Uncompacted, non pattern-densified tissue paper structures are also contemplated within the scope of the present invention and are described in U.S. Pat. No. 3,812,000 issued to Joseph L. Salvucci, Jr. and Peter N. Yiannos on May 21, 1974, and U.S. Pat. No. 4,208,459, issued to Henry E. Becker, Albert L. McConnell, and Richard Schutte on Jun. 17, 1980.

The softening composition of the present invention can also be applied to uncreped tissue paper. Uncreped tissue paper, a term as used herein, refers to tissue paper which is non-compressively dried, most preferably by through air drying. Resultant through air dried webs are pattern densified such that zones of relatively high density are dispersed within a high bulk field, including pattern densified tissue wherein zones of relatively high density are continuous and the high bulk field is discrete. The techniques to produce uncreped tissue in this manner are taught in the prior art. For example, Wendt, et. al. in European Patent Application 0 677 612A2, published Oct. 18, 1995; Hyland, et. al. in European Patent Application 0 617 164 A1, published Sept. 28, 1994; and Farrington, et. al. in U.S. Pat. No. 5,656,132 published Aug. 12, 1997.

The papermaking fibers utilized for the present invention will normally include fibers derived from wood pulp. Other cellulosic fibrous pulp fibers, such as cotton linters, bagasse, etc., can be utilized and are intended to be within the scope of this invention. Synthetic fibers, such as rayon, polyethylene and polypropylene fibers, may also be utilized in combination with natural cellulosic fibers. One exemplary polyethylene fiber which may be utilized is Pulpex®, available from Hercules, Inc. (Wilmington, Del.).

Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, are preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. Also applicable to the present invention are fibers derived from recycled paper, which may contain any or all of the above categories as well as other non-fibrous materials such as fillers and adhesives used to facilitate the original papermaking.

Other materials can be added to the aqueous papermaking furnish or the embryonic web to impart other desirable characteristics to the product or improve the papermaking process so long as they are compatible with the chemistry of the softening composition and do not significantly and adversely affect the softness or strength character of the present invention. The following materials are expressly included, but their inclusion is not offered to be all-inclusive. Other materials can be included as well so long as they do not interfere or counteract the advantages of the present invention.

It is common to add a cationic charge biasing species to the papermaking process to control the zeta potential of the aqueous papermaking furnish as it is delivered to the papermaking process. These materials are used because most of the solids in nature have negative surface charges, including the surfaces of cellulosic fibers and fines and most inorganic fillers. One traditionally used cationic charge biasing species is alum. More recently in the art, charge biasing is done by use of relatively low molecular weight cationic synthetic polymers preferably having a molecular weight of no more than about 500,000 and more preferably no more than about 200,000, or even about 100,000. The charge densities of such low molecular weight cationic synthetic polymers are relatively high. These charge densities range from about 4 to about 8 equivalents of cationic nitrogen per kilogram of polymer. An exemplary material is Cypro 514®, a product of Cytec, Inc. of Stamford, Conn. The use of such materials is expressly allowed within the practice of the present invention.

The use of high surface area, high anionic charge microparticles for the purposes of improving formation, drainage, strength, and retention is taught in the art. See, for example, U.S. Pat. No. 5,221,435, issued to Smith on Jun. 22, 1993, the disclosure of which is incorporated herein by reference.

If permanent wet strength is desired, cationic wet strength resins can be added to the papermaking furnish or to the embryonic web. Suitable types of such resins are described in U.S. Pat. No. 3,700,623, issued on Oct. 24, 1972, and U.S. Pat. No. 3,772,076, issued on Nov. 13, 1973, both to Keim.

Many paper products must have limited strength when wet because of the need to dispose of them through toilets into septic or sewer systems. If wet strength is imparted to these products, fugitive wet strength, characterized by a decay of part or all of the initial strength upon standing in presence of water, is preferred. If fugitive wet strength is desired, the binder materials can be chosen from the group consisting of dialdehyde starch or other resins with aldehyde functionality such as Co-Bond 1000® offered by National Starch and Chemical Company of Scarborough, Me.; Parez 750® offered by Cytec of Stamford, Conn.; and the resin described in U.S. Pat. No. 4,981,557, issued on Jan. 1, 1991, to Bjorkquist, and other such resins having the decay properties described above as may be known to the art.

If enhanced absorbency is needed, surfactants may be used to treat the tissue paper webs of the present invention. The level of surfactant, if used, is preferably from about 0.01% to about 2.0% by weight, based on the dry fiber weight of the tissue web. The surfactants preferably have alkyl chains with eight or more carbon atoms. Exemplary anionic surfactants include linear alkyl sulfonates and alkylbenzene sulfonates. Exemplary nonionic surfactants include alkylglycosides including alkylglycoside esters such as Crodesta SL-40® which is available from Croda, Inc. (New York, N.Y.); alkylglycoside ethers as described in U.S. Pat. No. 4,011,389, issued to Langdon, et al. on Mar. 8, 1977; and alkylpolyethoxylated esters such as Pegosperse 200 ML available from Glyco Chemicals, Inc. (Greenwich, Conn.) and IGEPAL RC-520® available from Rhone Poulenc Corporation (Cranbury, N.J.). Alternatively, cationic softener active ingredients with a high degree of unsaturated (mono and/or poly) and/or branched chain alkyl groups can greatly enhance absorbency.

While the preferred embodiment of the present invention discloses a certain softening agent composition deposited on the tissue web surface, the invention also expressly includes variations in which the chemical softening agents are added as a part of the papermaking process. For example, chemical softening agents may be included by wet end addition. In addition, other chemical softening agents, in a form not within the scope of the present invention may be used. Preferred chemical softening agents comprise quaternary ammonium compounds including, but not limited to, the well-known dialkyldimethylammonium salts (e.g., ditallowdimethylammonium chloride, ditallowdimethylammonium methyl sulfate, di(hydrogenated tallow)dimethyl ammonium chloride, etc.). Particularly preferred variants of these softening agents include mono or diester variations of the before mentioned dialkyldimethylammonium salts and ester quaternaries made from the reaction of fatty acid and either methyl diethanol amine and/or triethanol amine, followed by quaternization with methyl chloride or dimethyl sulfate.

Another class of papermaking-added chemical softening agents comprise the well-known organo-reactive polydimethyl siloxane ingredients, including the most preferred amino functional polydimethyl siloxane.

Filler materials may also be incorporated into the tissue papers of the present invention. U.S. Pat. No. 5,611,890, issued to Vinson et al. on Mar. 18, 1997, and, incorporated herein by reference discloses filled tissue paper products that are acceptable as substrates for the present invention.

The above listings of optional chemical additives is intended to be merely exemplary in nature, and are not meant to limit the scope of the invention.

Embossed Image

The embossed image 20 comprises any perceptible pattern in the tissue-towel substrate resulting from the deformation and/or compaction of the structure of the tissue-towel products. The pattern may include, but are not limited to, geometric figures, linework, representations of objects, words, general background areas, and the like.

The embossing image 20 may be disposed onto one of the plies of the paper web by any rotary embossing equipment. “Embossing” refers to the process of deflecting a relatively small portion of the substrate in a direction normal to its plane and impacting the deflected portion of the substrate against a relatively hard surface to permanently disrupt the structure of the substrate. Any embossing process known in the industry may be used in the process of the present invention.

Embossing is typically performed by one of two processes, knob-to-knob embossing or nested embossing. Knob-to-knob embossing consists of axially parallel rolls and juxtaposed to form a nip between the knobs of opposing rolls having a width less than the thickness of the material to be embossed. Nested embossing consists of embossment knobs of one roll meshed between the embossment knobs of the other roll. Examples of knob-to-knob embossing and nested embossing are illustrated in the prior art by U.S. Pat. No. 3,414,459 issued Dec. 3, 1968 to Wells and commonly assigned; U.S. Pat. No. 3,547,723 issued Dec. 15, 1970 to Gresham; U.S. Pat. No. 3,556,907 issued Jan. 19, 1971 to Nystrand; U.S. Pat. No. 3,708,366 issued Jan. 2, 1973 to Donnelly; U.S. Pat. No. 3,738,905 issued Jun. 12, 1973 to Thomas; U.S. Pat. No. 3,867,225 issued Feb. 18, 1975 to Nystrand and U.S. Pat. No. 4,483,728 issued Nov. 20, 1984 to Bauernfeind; U.S. Pat. No. 3,867,225 issued Feb. 18, 1975 to Nystrand; U.S. Pat. No. 5,468,323 issued Nov. 21, 1995 to McNeil; and U.S. Pat. No. 6,277,466B1 issued Aug. 21, 2001 to McNeil et al.

Printed Image

The printed image 30 comprises any perceptible pattern on the tissue-towel product resulting from the application of printed materials to the surface of the web. While the printed materials are preferably printing inks, which can create a single or multi-color picture on the surface of the web, the present invention also contemplates the use of functional materials as printing materials. Such functional materials may include, but are not limited to dyes, glues or adhesives, fiber binders, softeners and the like. A single fluid image or multi-fluid image may be applied to the substrate. Preferably, the printed image 30 comprises one or more inks applied to the substrate.

Printing processes suitable for this invention may be any rotary printing application known in the industry. These include, but are not limited to: lithography, letterpress, gravure, screen printing, intaglio and preferably flexography. Likewise, combinations and variations thereof are considered to be within the scope of the present invention. In general, the rotary printing process comprises a printing unit and a counterpressure roller. Devices suitable for applying an image onto the preferred substrate of absorbent tissue-towel paper in accordance with the present invention are described in commonly assigned U.S. Pat. No. 5,213,037 issued to Leopardi, II on May 25, 1993; U.S. Pat. No. 5,255,603 issued to Sonneville et al. issued on Oct. 26, 1993; and U.S. Pat. No. 6,096,412 issued to McFarland et al. on Aug. 1, 2000.

The printed image 30 produced on the paper can be line work, halftoning, a process print, or a combination of these. As used herein, “process print” refers to a halftone color print created by the color separation process whereby an image composed of two or more transparent inks is broken down into halftone dots which can be recombined to produce the complete range of colors of the original image.

The embossed image 20 and the printed image 30 of the absorbent tissue-towel products of the present invention are related by the same subject matter association. By “subject matter association” it is meant a relationship in meaning of specific objects that is unique to the special subject matter. The relationship is more than one developed simply because two objects look good together on the tissue product.

The first requirement is that both the printed image and the embossed image each represent a tangible idea or object. A random or non-random pattern of lines, geometric figures, etc. that do not represent a tangible idea are not contemplated by the present invention. The second requirement is that the tangible idea or object represented by the printed image must be uniquely identifiable to the tangible idea or object represented by the embossed image. The strength of the unique relationship is increased with higher levels of cultural, professional, and literary affiliation. For example, simple images of a bear with a little girl, or a dog with a bird, or a flower with a tree would not be uniquely related to a specific subject matter to develop the synergistic story to be of value in the present tissue-towel product. However, alter these images slightly to show Goldilocks and her three bears, or to show Snoopy with Woodstock, or to show cherry blossoms with cherry trees and the unique association with a specific subject matter has been established to be related for the present products.

Natural association refers to the relationship of images and patterns to a specific natural occurrence or group of occurrences. These images and patterns could include, but are not limited to, representations of people, animals, plants, objects and symbols of the natural occurrence. One representative example of natural occurrences and their related images could include animals, their features, references to the noise they make, and items uniquely related to that animal (e.g. objects selected from cats, cat paws, representations of the word “Meow”, balls of yard, etc.) Other representative examples of natural occurrence and their related images could include rainforests and its elements, the beach and its elements, and the like. Special relationships exist within different kingdoms of species in nature. The kingdom of birds could be represented by different birds, the kingdom of flowers could be represented by different flowers, etc.

Professional association refers to the relationship of images and patterns to a specific profession or group of professions. These images and patterns could include, but are not limited to, representations of people, objects and symbols of the profession or groups of professions. Representative examples of professions and their related images could include: firefighting profession represented by objects selected from firefighters, firetrucks, hoses, ladders, etc.; the medical profession represented by objects selected from doctors, nurses, stethoscopes, syringes, etc.; the aeronautical field represented by astronauts, rockets, moons, etc.

Business association refers to the relationship of images and patterns to a specific business or group of businesses. These images and patterns could include, but are not limited to, representations of people, objects and symbols of the selected business. Representative examples of businesses and their related images could include: Procter & Gamble Company represented by its objects, images and marks selected from its official log, the trademarks of its various products, and images representing those products; or the National Football League represented by objects, images and mark selected from its official logo, the logos of its various teams and images of footballs, goalposts, and the like.

Artistic and literary association refers to the relationship of images and patterns to a specific work of art or a literary work. Herein, work of art and literary works include well known drawings, portraits, sculptures, stories, novels, fables, nursery rhymes, cartoons, movies, television shows and the like. These images and patterns could include, but are not limited to, representations of people, objects and symbols in a specific work or set of works. Representative examples of literary or artistic works and their related images could include: The Peanuts cartoon characters and images selected from those characters and their associated items (e.g., Snoopy's doghouse, Linus' blanket, etc.); and the Harry Potter line of books represented by images and objects selected from the characters and the objects associated with them (e.g., magic wands, lightning bolts, etc.). Cultural association refers to the relationship of images and patterns to a specific cultural event or ideal. These images and patterns could include, but are not limited to, representations of people, objects and symbols of a specific culture. Representative examples of cultures and their related images could include: the African celebration of Kwanzaa represented by the objects selected from the Mkeka, the Kinara, Muhindi, etc.; the Hispanic celebration of Cinco de Mayo represented by objects selected from the Mexican Flag, Mexican hats, piñatas, dance skirts, etc.; and the Jewish celebration of Hanukkah represented by objects selected from dradles, minorahs, Stars of David, etc.

Recreational association refers to the relationship of images and patterns to a specific recreation activity or activities. These images and patterns could include, but are not limited to, representations of people, objects and symbols of those activities. Representative examples of recreational activities and their related images could include: fishing represented by objects selected from fishing rods, boats, fish, tackle, etc.; sewing represented by objects selected from needles, thread, thimbles, cloth, patterns, etc.; sports represented by objects selected from the various sets of sports equipment, images of players, etc. Other examples can be found in U.S. Pat. No. 6,297,424B1 issued to Olson et al. on Oct. 2, 2001 and U.S. Pat. No. 6,307,119B1 issued to Cammarota et al. on Oct. 23, 2001.

Objects are related if one is a piece or subset of the other object, or is both are pieces or subsets of the same larger object. Likewise, objects are related if the images are simply scaled (i.e. reduced or enlarged in magnification) or symmetric images of an original image. The most direct application of this is the embossing of the tissue-towel product with an outline of the same image that is printed on the product.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An absorbent tissue-towel product comprising:
a) paper substrate having a first surface and a second surface;
b) a printed image disposed on at least one of first or second surfaces; and
c) an embossed image disposed on at least one of first or second surfaces;
wherein the embossed image and the printed image both represent elements of the same subject matter association.

2. An absorbent tissue-towel product according to claim 1 wherein the embossed image and the printed image both represent elements of the same natural association.

3. An absorbent tissue-towel product according to claim 1 wherein the embossed image and the printed image both represent elements of the same professional association.

4. An absorbent tissue-towel product according to claim 1 wherein the embossed image and the printed image both represent elements of the same business association.

5. An absorbent tissue-towel product according to claim 1 wherein the embossed image and the printed image both represent elements of the same artistic association.

5. An absorbent tissue-towel product according to claim 1 wherein the embossed image and the printed image both represent elements of the same literary association.

6. An absorbent tissue-towel product according to claim 1 wherein the embossed image and the printed image both represent elements of the same cultural association.

7. An absorbent tissue-towel product according to claim 1 wherein the embossed image represents an associated part of an object represented in the printed image.

8. An absorbent tissue-towel product according to claim 1 wherein the printed image represents an associated part of an object represented in the embossed image.

9. An absorbent tissue-towel product according to claim 1 wherein the embossed image represents a natural object in the same kingdom as the representation of the printed image.

10. An absorbent tissue-towel product according to claim 1 wherein the embossed image represents a proportional representation of an outline or shadow of the shape in the printed image.

11. An absorbent tissue-towel product according to claim 10 where the embossed image is at the same scale as the printed image.
